(19) United States
(12) Patent Application Publication
(10) Pub. No.: US 2021/0292481 A1
(43) Pub. Date: Sep. 23, 2021

(54) METHOD FOR MANUFACTURING A THREE-DIMENSIONAL OBJECT FROM A POLY(ARYLENE SULFIDE) POLYMER

(71) Applicant: SOLVAY SPECIALTY POLYMERS USA, LLC, Alpharetta, GA (US)

(72) Inventors: Ryan HAMMONDS, Atlanta, GA (US); Lee CARVELL, Cumming, GA (US); Jason RICH, Roswell, GA (US); Stéphane JEOL, Saint-Genis Laval (FR); William E. SATTICH, Cumming, GA (US)

(21) Appl. No.: 17/258,472

(22) PCT Filed: Jul. 12, 2019
(86) PCT No.: PCT/EP2019/068852

§ 371 Date: Jan. 7, 2021

Related U.S. Application Data
(60) Provisional application No. 62/697,068, filed on Jul. 12, 2018.

(30) Foreign Application Priority Data
Aug. 14, 2018 (EP) 18188972.6

(51) Int. Cl. C08G 75/0277; C08J 3/12; C08L 81/02; B33Y 10/00; B33Y 70/00; B29C 64/153; B33Y 40/10; B29C 64/314

(52) U.S. Cl. CPC C08G 75/0277; C08J 3/12; C08L 81/02; B33Y 10/00; B33Y 70/00; B29K 2081/04; B33Y 40/10; B29C 64/314; C08J 2381/02; C08J 2481/02; B29C 64/153

(57) ABSTRACT

The invention pertains to a powdered material (M) comprising at least one poly(arylene sulfide) polymer, in particular to a method for manufacturing a three-dimensional (3D) object, using the powdered material (M) and to 3D object obtainable by selective sintering from this powdered polymer material (M).

### RELATED APPLICATIONS

This application claims priority to US Provisional Application No. 62/filed on 12 Jul. 2018 and EP Application No 18188973.4 filed on 14 Aug. 2018 the whole content of each of these applications being incorporated herein by reference for all purposes.

### TECHNICAL FIELD

The present disclosure relates to a method for manufacturing a three-dimensional (3D) object, using a powdered material (M) comprising at least one poly(arylene sulfide) polymer. The present invention also relates to a 3D object obtainable by selective sintering from this powdered material (M).

### BACKGROUND ART

Additive manufacturing systems are used to print or otherwise build 3D objects from a digital blueprint created with computer-aided design (CAD) modelling software. Selective laser sintering (“SLS”), one of the available additive manufacturing techniques, uses electromagnetic radiation from a laser to fuse powdered materials into a mass. The laser selectively fuses the powdered material (also called sometimes build material) by scanning cross-sections generated from the digital blueprint of the object on the surface of a powder bed. After a cross-section is scanned, the powder bed is lowered by one layer thickness, a new layer of material is applied, and the bed is rescanned. Locally full coalescence of polymer particles in the top powder layer is necessary as well as an adhesion with previous sintered layers. This process is repeated until the object is completed.

Multi jet fusion (“MJP”) is another example of an additive manufacturing printing method. During multi jet fusion, the entire layer of the powdered material is exposed to radiation, but only a selected region is fused and hardened to become a layer of a 3D object. The MJP method makes use of a fusing agent, which has been selectively deposited in contact with the selected region of the powdered material. The fusing agent is capable of penetrating into the layer of the powdered material and spreading onto the exterior surface of the powdered material. The fusing agent is capable of absorbing radiation and converting the absorbed radiation to thermal energy, which in turn melts or sinters the powdered material that is in contact with the fusing agent. This causes the powdered material to fuse, bind, and cure, in order to form a layer of the 3D object.

Composite-based additive manufacturing technology (“CBAM”) is yet another AM printing method to make parts from fiber-reinforced composites, such as carbon, Kevlar and glass fiber fabrics bonded with thermoplastic matrix materials. A liquid is selectively deposited on a fiber substrate layer which is then flooded with powdered material. The powdered material adheres to the liquid and the excess powder is removed. These steps are repeated and the fiber substrate layers are stacked in a predetermined order to create a 3D object. Pressure and heat are applied to the layers of substrate being fused, melting the powdered material and pressing the layers together.

The compacting and consolidation behaviour of polymeric powders under motion and agitation is one key feature of manufacturing methods using polymeric part material in the form of powders, as it is for example the case during powder distribution by roller or blade spreading in commercial SLS systems. The ability of powders to generate a certain density or packing is reflected in the density of printed objects and finally in their mechanical properties. In that respect, the powder flowability is one of the essential features to target during the development process.

One of the fundamental limitations associated with known additive manufacturing methods using polymeric part material in the form of a powder is based on the lack of identification of a material which presents sufficient flow properties in order to print 3D parts/objects with acceptable density and mechanical properties.

The method of manufacturing a 3D object of the present invention is based on the use of a powdered material comprising at least one poly(arylene sulfides) (PAS), wherein the powdered material exhibits superior flow properties, which makes it well-suited for additive manufacturing methods making use of a build material in the form of a powder.

### SUMMARY OF INVENTION

An aspect of the present disclosure is directed to a powdered material (M) for laser sintering, comprising a polymeric component (P) comprising at least one poly(arylene sulfide) polymer (PAS), having a melt flow rate (at 316° C. under a weight of 5 kg according to ASTM D1238, procedure B) of less than 160 g/10 min.

According to an embodiment, the material (M) has an average flow time such that its passage time in a 17 mm funnel is less than 35 s, preferably less than 30 s, even more preferably less than 28 s, and optionally an average number of taps to flow of less than 30 taps.

Another aspect of the invention is directed to a method for manufacturing a three-dimensional (3D) object, comprising:
a) depositing successive layers of the powdered material (M) of the present invention
b) selectively sintering each layer prior to deposition of the subsequent layer.

Step b) may notably comprise selective sintering by means of an electromagnetic radiation of the powder.

The present invention also relates to a three-dimensional (3D) object obtainable by laser sintering from the powdered material (M) of the invention, as well as to the use of this powdered material (M) for the manufacture of a three-dimensional (3D) object using additive manufacturing, preferably selective laser sintering (SLS), composite-based additive manufacturing technology (“CBAM”) or jet mill fusion (JMF) and the use of a poly(arylene sulfide) polymer (PAS) for the manufacture of powdered material (M) having an average flow time such that its passage time in a 17 mm funnel is less than 35 s, preferably less than 30 s, even more preferably less than 28 s.

### DESCRIPTION OF EMBODIMENTS

Disclosed herein are powdered materials and methods of manufacturing a 3D object from the powdered material comprising at least one poly(arylene sulfide) polymer, also referred to herein as “poly(arylene sulfide)” or PAS. Reference to poly(arylene sulfide) polymer specifically includes, without limitation, polyphenylene sulfide polymer also referred to herein as “polyphenylene sulphide” or PPS.

The powdered material (M) of the invention presents a flowability which makes the material (M) well-suited for applications such as the manufacture of 3D objects using a laser-sintering based additive manufacturing system in which the powder has to present good flow behaviors in order to facilitate the packing of the powder during the printing process. Notably, the powdered material of the invention is such that it presents an average flow time (or flowability) such that the passage time in a 17 mm glass funnel is less than 35 s, preferably less than 30 s or less than 28 s, as measured according to a method wherein the glass funnel is filled with the powdered material (M) up to 5 mm from the top, the cap blocking the bottom orifice of the funnel is removed, and the flow time of the powder is measured with a stopwatch.

The average flow time can notably be measured using a glass funnel with a bottom orifice of 17 mm according to the following method:
the glass funnel is filled with the powdered material (M) up to 5 mm from the top,
the cap blocking the bottom orifice is removed,
the flow time of the powder is measured with a stopwatch.

If flow does not take place, or if the flow stops, the funnel is tapped with a tool (e.g. a marker or a spatula) until the flow resumes. The total flow time and the number of taps using the tool are recorded. For a given powder, the experiment is repeated 3 times, and the average total flow time and the average number of taps are reported.

The dimensions of the funnel used to measure the average flow time can for example be as follows dₑ=40 mm, dₒ=17 mm, h=110 mm and h₁=70 mm.

According to the present invention, the melt flow rate (at 316° C. under a weight of 5 kg according to ASTM D1238, procedure B) of the PPS is less than 160 g/10 min, for example less than 150 g/10 min, less than 140 g/10 min or less than 135 g/10 min.

The method for manufacturing a 3D object of the present invention employs a powdered material (M) comprising a polymeric component (P) comprising at least one PAS polymer, for example as the main element of the material (M), optionally at least one flow agent (F) and/or at least one additive (A), for example in a quantity less than 10 wt. %, based on the total weight of the material (M). The powdered material (M) can have a regular shape such as a spherical shape, or a complex shape obtained by grinding/milling of the polymeric component (P), at least the PAS polymer, in the form of pellets or coarse powder.

In the present application:
any description, even though described in relation to a specific embodiment, is applicable to and interchangeable with other embodiments of the present disclosure;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

The present invention relates to a method for manufacturing a three-dimensional (3D) object, comprising depositing successive layers of a powdered material (M) and selectively sintering each layer prior to deposition of the subsequent layer, for example by means of an electromagnetic radiation of the powder.

SLS 3D printers are, for example, available from EOS Corporation under the trade name EOSINT® P.

MJF 3D printers are, for example, available from Hewlett-Packard Company under the trade name Jet Fusion.

The powder may also be used to produce continuous fiber composites in a CBAM process, for example as developed by Impossible Objects.

The powdered material (M) of the present invention comprises a polymeric component (P) comprising at least one poly(arylene sulfide) polymer (PAS).

The powdered material (M) of the invention may include other components. For example, the material (M) may comprise at least one flow aid (F) and/or at least one additive (A), notably at least one additive selected from the group consisting of fillers, colorants, dyes, pigments, lubricants, plasticizers, flame retardants (such as halogen and halogen-free flame retardants), nucleating agents, heat stabilizers, light stabilizers, antioxidants, processing aids, fusing agents, electomagnetic absorbers and combinations thereof.

According to one embodiment, the material (M) of the present invention comprises:
at least 50 wt. % of the polymeric component (P) comprising at least one PAS or PPS,
optionally at least one flow agent (F), for example from 0.01 to 10 wt. %, from 0.05 to 8 wt. %, from 0.1 to 6 wt. % or from 0.5 to 5 wt. % of at least one flow agent (F), and
optionally at least one additive (A), for example selected from the group consisting of fillers (such as milled carbon fibers, silica beads, talc, calcium carbonates), colorants, dyes, pigments, lubricants, plasticizers, flame retardants (such as halogen and halogen-free flame retardants), nucleating agents, heat stabilizers, light stabilizers, antioxidants, processing aids, fusing agents and electomagnetic absorbers, for example from 0.01 to 10 wt. %, from 0.05 to 8 wt. %, from 0.1 to 6 wt. % or from 0.5 to 5 wt. % of at least one additive (A), based on the total weight of the powdered polymer material (M).

According to one embodiment, the material (M) of the present invention comprises at least 60 wt. % of the polymeric component (P), for example at least 70 wt. %, at least 80 wt. %, at least 90 wt. %, at least 95 wt. % or at least 99 wt. % of the polymeric component (P) described herein.

Generally, poly(arylene sulfide) is a polymer comprising —(Ar—S)— recurring units, wherein Ar is an arylene group, also called herein recurring unit (R_{PAS}). The arylene groups of the PAS can be substituted or unsubstituted. Additionally, the PAS can include any isomeric relationship of the sulfide linkages in polymer; e.g., when the arylene group is a phenylene group, the sulfide linkages can be ortho, meta, para, or combinations thereof.

According to an embodiment, the PAS comprises at least 5, at least 10, at least 20, at least 30, at least 40, at least 50, at least 60, at least 70, at least 80, at least 90, at least 95, at least 98 mol. % of recurring units (R_{PAS}), based on the total number of moles in the PAS. According to an embodiment, the PAS consists essentially in recurring units (R_{PAS}).

According to an embodiment, the PAS polymer is selected from the group consisting of poly(2,4-toluene sulfide), poly(4,4′-biphenylene sulfide), poly(para-phenylene sulfide) (PPS), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecylphenylene sulfide), poly(phenylphenylene sulfide), poly-(tolylphenylene sulfide), poly(benzylphenylene sulfide) and poly[octyl-4-(3-methylcyclopentyl)phenylene sulfide].

According to an embodiment, the PAS is a polyphenylene sulfide polymer (PPS), and comprises recurring units (R_{PPS}) represented by Formula I:

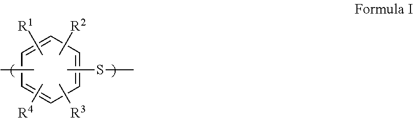

wherein R¹, R², R³, and R⁴ independently can be hydrogen or a substituent, selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

In its broadest definition, the polyphenylene sulfide polymer (PPS) of the present invention can therefore be made of substituted and/or unsubstituted phenylene sulfide groups.

According to another embodiment, the PPS comprises recurring units (R_{PPS}) represented by Formula II:

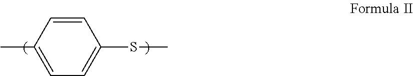

According to an embodiment of the present invention, the PPS comprises at least 50 mol. % of recurring units (R_{PPS}) of Formula I and/or II, based on the total number of moles in the PPS polymer. For example at least about 60 mol. %, at least about 70 mol. %, at least about 80 mol. %, at least about 90 mol. %, at least about 95 mol. %, at least about 99 mol. % of the recurring units in the PPS are recurring units (R_{PPS}) of Formula I and/or II.

According to an embodiment of the present invention, the PPS polymer is such that about 100 mol. % of the recurring units are recurring units (R_{PPS}) of Formula I and/or II. According to this embodiment, the PPS polymer consists essentially of recurring units (R_{PPS}) of Formula I and/or II.

The PAS polymer of the present invention can be obtained by a process known in the art. Reference can notably be made to WO 2015/095362 A1 (Chevron Philipps), WO 2015/177857 A1 (Solvay) and WO 2016/079243 A1 (Solvay), incorporated herein by reference.

The PAS polymer employed in the method of the present invention may notably be obtained by a process comprising:
Step 1) polymerizing reactants in a reaction vessel to produce a PAS reaction mixture;
Step 2) processing the PAS reaction mixture to obtain a PAS polymer and a by-product slurry;
Step 3) recovering the PAS polymer, for example by precipitation or by evaporation; and
Step 4) treating the PAS polymer with aqueous calcium salt solution and/or water and/or an aqueous acid solution.

Step 4) can consists in treating (or washing) the PAS polymer with calcium, water, an aqueous acid solution or a combination thereof. The PAS polymer can be treated or washed several times. The PAS polymer which undergoes the treating of Step 4) can either be in a dry form or in a solution.

According to an embodiment of Step 4), the PAS is contacted, for example blended, with an aqueous calcium salt solution, water and/or an aqueous acid solution to form a mixture. The concentration of PAS in the mixture can range from about 1 wt. % to about 50 wt. %, from about 5 wt. % to about 40 wt. %, or from about 10 wt. % to about 30 wt. %, based upon the total weight of the mixture.

The aqueous acid solution which may be employed in Step 4) comprises an acidic compound. The acidic compound can be any organic acid or inorganic acid which is water soluble. According to an embodiment, the organic acid which can be utilized is a C1 to C15 carboxylic acid, for example a C1 to C10 carboxylic acid or a C1 to C5 carboxylic acid. According to an embodiment, the organic acid which can be utilized is selected in the group consisting of acetic acid, formic acid, oxalic acid, fumaric acid, and monopotassium phthalic acid. Preferably the organic acid is acetic acid. Inorganic acids which can be utilized can be selected in the group consisting of hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid.

The amount of the acidic compound present in the aqueous acidic solution or in the mixture can range from 0.01 wt. % to 10 wt. %, from 0.025 wt. % to 5 wt. %, or from 0.075 wt. % to 1 wt. % based on the total amount of water in the solution/mixture.

The solution/mixture can be heated to a temperature below the melting point of the PAS. The temperature of the solution/mixture in Step 4) can range from about 10 to 165° C., from 15 to 150° C. or from about 20 to 125° C. Alternatively, The temperature of the solution/mixture in Step 4) can range from 175 to 275° C., or from 200 to 250° C.

According to another embodiment, the melt crystallization temperature (Tmc) of the poly(arylene sulfide) (PAS) of the present invention is at least 220° C. as measured by differential scanning calorimetry (DSC) according to ASTM D3418, for example at least 225° C. or at least 230° C.

According to an embodiment of the present invention, the polymeric component (P) of the powdered material (M) comprises at least 50 wt. % of PAS or PPS, based on the total weight of the polymeric component in the powdered material (M). For example, the component (P) of the material (M) comprises at least 55 wt. % of PAS or PPS, at least 60 wt. % of PAS or PPS, at least 65 wt. % of PAS or PPS, at least 70 wt. % of PAS or PPS, at least 75 wt. % of PAS or PPS, at least 80 wt. % of PAS or PPS, at least 85 wt. % of PAS or PPS, at least 90 wt. % of PAS or PPS, at least 95 wt. % of PAS or PPS or even at least 98 wt. % of PAS or PPS.

According to another embodiment of the present invention, the component (P) of the material (M) comprises more than 99 wt. % of PAS or PPS, based on the total weight of the component (P) in the material (M).

According to another embodiment of the present invention, the component (P) of the material (M) consists essentially in PAS or PPS polymers.

The material (M) may comprise at least one flow agent (F). The flow agent is also called sometimes flow aid. The flow agent used in the present invention may for example be hydrophilic. Examples of hydrophilic flow aids are inorganic pigments notably selected from the group consisting of silicas, aluminas and titanium oxide. Mention can be made of fumed silica.

Fumed silicas are commercially available under the trade name Aerosil® (Evonik) and Cab-O-Sil® (Cabot).

According to an embodiment of the present invention, the material (M) comprises up to 10 wt. %, for example from 0.01 to 8 wt. %, from 0.1 to 6 wt. % or from 0.5 to 5 wt. % of at least one flow agent (F), for example of at least fumed silica.

These silicas are composed of nanometric primary particles (typically between 5 and 50 nm for fumed silicas). These primary particles are combined to form aggregates. In use as flow agent, silicas are found in various forms (elementary particles and aggregates).

The material (M) may comprise at least one additive (A), for example selected from the group consisting of fillers (such as milled carbon fibers, silica beads, talc, calcium carbonates), colorants, dyes, pigments, lubricants, plasticizers, flame retardants (such as halogen and halogen-free flame retardants), nucleating agents, heat stabilizers, light stabilizers, antioxidants, processing aids, fusing agents, electomagnetic absorbers and combinations thereof.

According to another embodiment of the present invention, the material (M) comprises up to 10 wt. %, for example from 0.01 to 8 wt. %, from 0.1 to 6 wt. % or from 0.5 to 5 wt. % of at least one additive (A) selected from the group consisting of fillers, colorants, dyes, pigments, lubricants, plasticizers, flame retardants (such as halogen and halogen-free flame retardants), nucleating agents, heat stabilizers, light stabilizers, antioxidants, processing aids, fusing agents, electomagnetic absorbers and combinations thereof.

According to an embodiment, the powdered material (M) of the present invention has a d_{0.5}-value ranging between 40 and 80 μm, as measured by laser scattering in isopropanol, for example a d_{0.5}-value ranging between 41 and 70 μm or between 42 and 60 μm. The d_{0.5}, also called D50, is known as the median diameter or the medium value of the particle size distribution. It is the value of the particle diameter at 50% in the cumulative distribution. It means that 50% of the particles in the sample are larger than the d_{0.5}-value, and 50% of the particles in the sample are smaller than the d_{0.5}-value. D50 is usually used to represent the particle size of a group of particles.

According to another embodiment, the powdered material (M) of the present invention has a d_{0.9}-value of less than 120 μm, as measured by laser scattering in isopropanol, for example a d_{0.9}-value of less than 110 μm or even less than 105 μm. The powdered material (M) of the present invention may for example have a d_{0.9}-value comprised between 50 and 120 μm, for example between 55 and 115 μm or between 60 and 108 μm. The d_{0.9}, also called D90, is the value of the particle diameter at 90% in the cumulative distribution. It means that 90% of the particles in the sample are smaller than the d_{0.9}-value.

According to another embodiment yet, the powdered material (M) of the present invention has a doss-value of less than 230 μm, as measured by laser scattering in isopropanol, for example a doss-value of less than 220 μm or even less than 210 μm. The powdered material (M) of the present invention may for example have a doss-value of less than 150 μm or even less than 145 μm. The d_{0.99}, also called D99, is the value of the particle diameter at 99% in the cumulative distribution. It means that 99% of the particles in the sample are smaller than the doss-value, for example that 99% of the particles in the powdered material (M) are smaller than 230 μm.

The powdered material (M) employed in the method of the present invention may be obtained by:
Step 1′) grinding the polymeric component (P), optionally cooled down to a temperature below 25° C. before and/or during grinding; and Step 2′) blending the polymeric component (P) from Step 1′) with the optional ingredients, e.g. at least a flow agent (F) or at least one additive (A).

The material (M) employed in the method of the present invention may alternatively be obtained by:
Step 1″) blending the polymeric component (P) with optional ingredients, e.g. at least a flow agent (F) or at least one additive (A), and
Step 2″) grinding the blend from Step 1″), optionally cooled down to a temperature below 25° C. before and/or during grinding.

The grinding step can take place in a pinned disk mill, a jet mill/fluidized jet mil with classifier, an impact mill plus classifier, a pin/pin-beater mill or a wet grinding mill, or a combination of those equipment.

The ground powdered material can be separated or sieved, preferably in an air separator or classifier, to obtain a predetermined fraction spectrum. The powdered material (M) is preferably sieved before use in the printer. The sieving consists in removing particles bigger than 200 μm, than 150 μm, than 140 μm, 130 μm, 120 μm, 110 μm, or bigger than 100 μm, using the appropriate equipment.

The present invention also relates to a method for manufacturing a three-dimensional (3D) object with an additive manufacturing system which comprises the step of printing layers of the 3D object/article/part from a part material comprising the powdered material (M) described herein.

According to an embodiment, the process comprises at least two steps:
the provision of a powdered material (M) as described herein, and
a step consisting in printing layers of the three-dimensional (3D) object from the material (M).

According to an embodiment, the step of printing layers comprises the selective sintering of the powdered material (M) by means of an electromagnetic radiation of the PAS/PPS powder, for example a high power laser source such as an electromagnetic beam source.

The 3D object/article/part may be built on substrate, for example an horizontal substrate and/or on a planar substrate. The substrate may be moveable in all directions, for example in the horizontal or vertical direction. During the 3D printing process, the substrate can, for example, be lowered, in order for the successive layer of unsintered polymeric material to be sintered on top of the former layer of sintered polymeric material.

According to an embodiment, the process further comprises a step consisting in producing a support structure. According to this embodiment, the 3D object/article/part is built upon the support structure and both the support structure and the 3D object/article/part are produced using the same AM method. The support structure may be useful in multiple situations. For example, the support structure may be useful in providing sufficient support to the printed or under-printing, 3D object/article/part, in order to avoid distortion of the shape 3D object/article/part, especially when this 3D object/article/part is not planar. This is particularly true when the temperature used to maintain the printed or under-printing, 3D object/article/part is below the re-solidification temperature of the PAS/PPS powder.

The method of manufacture usually takes place using a printer. The printer may comprise a sintering chamber and a powder bed, both maintained at a specific temperature.

The powder to be printed can be pre-heated to a processing temperature (Tp), above the glass transition (Tg) temperature of the powder. The preheating of the powder makes it easier for the laser to raise the temperature of the selected regions of layer of unfused powder to the melting point. The laser causes fusion of the powder only in locations specified by the input. Laser energy exposure is typically selected based on the polymer in use and to avoid polymer degradation.

In some embodiments, the powder to be printed is pre-heated to a temperature Tp, which is below the melting point Tm of the PAS/PPS powder, for example to a processing temperature Tp (expressed in ° C.) as follows:

Tp≤Tm−5,
more preferably Tp≤Tm−10,
even more preferably Tp≤Tm−15,
   wherein Tm (° C.) is the melting temperature of the PAS/PPS polymer, as measured on the 1^{st} heat scan by differential scanning calorimetry (DSC) according to ASTM D3418. According to this embodiment, the processing temperature is precisely adjusted in a temperature sintering window.

In some embodiments, the processing temperature (Tp) is less than or equal to 285° C., preferably less than or equal to 280° C., and even more preferably less than or equal to 275° C.

The powdered material (M) of the present invention can be characterized by a specific average flow time. The average flow time is also hereby called equivalently flowability. The average flow time is measured using a glass funnel with a bottom orifice of 17 mm according to the following method:
the glass funnel is filled with the powdered material (M) up to 5 mm from the top,
the cap blocking the bottom orifice is removed,
the flow time of the powder is measured with a stopwatch.

If flow does not take place, or if the flow stops, the funnel is tapped with a tool (e.g. a marker or a spatula) until the flow resumes.

According to an embodiment, the powdered material (M) has:
an average flow time such that its passage time in a 17 mm funnel is less than 35 s, preferably less than 30 s or less than 28 s, and
an average number of taps to flow of less than 30, preferably less than 28, less than 25, less than 23, less than 20 and even more preferably less than 10 taps.

3D Objects and Articles

The present invention also relates to a 3D object or part, obtainable by laser sintering from the powdered material (M) of the present invention.

The present invention also relates to a 3D object or part, comprising the powdered material (M) of the present invention.

The present invention also relates to the use of the powdered material (M) of the present invention for the manufacture of a 3D object using additive manufacturing, preferably SLS, CBAM or JMF.

The present invention also relates to the use of a polymeric component (P) comprising at least one PAS, for the manufacture of a powdered material (M) for additive manufacturing, preferably SLS, CBAM or JMF.

The 3D objects or articles obtainable by such method of manufacture can be used in a variety of final applications. Mention can be made in particular of medical devices, brackets and complex shaped parts in the aerospace industry and under-the-hood parts in the automotive industry (e.g. thermostat housing, water pump impeller, engine covers, pump casing).

All the embodiments described above with respect to the polymeric component (P) and the powdered material (M) do apply equally to the 3D objects, the use of the component (P) or the use of the material (M).

Should the disclosure of any patents, patent applications, and publications which are incorporated herein by reference conflict with the description of the present application to the extent that it may render a term unclear, the present description shall take precedence.

Exemplary embodiments will now be described in the following non-limiting examples.

### EXAMPLES

The disclosure will be now described in more detail with reference to the following examples, whose purpose is merely illustrative and not intended to limit the scope of the disclosure.

Starting Materials

The following aromatic polyphenylene sulphide (PPS) polymers were prepared:

PPS #1: a polyphenylene sulphide (PPS) polymer with a MFR equal to 123 g/10 min (316° C./5 kg), as measured according to ASTM D1238 prepared according to the following process:

PPS #1 was synthesized and recovered from the reaction mixture according to methods described in U.S. Pat. Nos. 3,919,177 and 4,415,729, washed with deionized water for at least 5 minutes at 60° C., then contacted with an aqueous acetic acid solution having a pH of <6.0 for at least 5 minutes at 60° C., and subsequently rinsed with deionized water at 60° C.

PPS #2: a polyphenylene sulphide (PPS) polymers with a MFR equal to 210 g/10 min (316° C./5 kg), as measured according to ASTM D1238, prepared according to the following process:

PPS #2 was synthesized and recovered from the reaction mixture according to methods described in U.S. Pat. Nos. 3,919,177 and 4,415,729, washed with deionized water for at least 5 minutes at 60° C., and subsequently rinsed with deionized water at 60° C.

PPS #3: a polyphenylene sulphide (PPS) polymers with a MFR equal to 55 g/10 min (316° C./5 kg), as measured according to ASTM D1238.

PPS #4: a polyphenylene sulphide (PPS) polymers with a MFR equal to 130 g/10 min (316° C./5 kg), as measured according to ASTM D1238.

PPS #3 and PPS #4 were both synthesized and recovered from the reaction mixture according to methods described in U.S. Pat. Nos. 3,919,177 and 4,415,729, washed with deionized water for at least 5 minutes at 60° C., then contacted with about 0.01 mol/L aqueous calcium acetate solution for at least 5 minutes at 60° C., and subsequently rinsed with deionized water at 60° C.

PPS #3 and PPS #4 differ by their melt flow rates.

Calcium content of the PPS polymers was determined using an Energy Dispersive X-ray Fluorescence analyzer (EDXRF), measuring intensity of the calcium Kα line (at 3.691) at 12 kV and 315 mA for 100 seconds with 1.5 ms shaping, calibrated by using PPS standards of known calcium content as determined by Inductively Coupled Plasma Optical Emission Spectroscopy (ICP-AES) according to ASTM UOP714-07.

Preparation of Powders

Powders were generated by grinding raw PPS resin flakes using a Retsch SR300 grinder fitted with a 0.08-mm screen. In examples 5-8, the resulting powders were sieved using a No. 120 ASTM E-11 standard testing sieve tray from W.S Tyler, Inc. having a pore size rating of 125 μm. The sieve tray was loaded onto a Ro-Tap® Model B Testing Sieve Shaker from W.S. Tyler, Inc.

Test Methods

Flowability

The average flow time is measured using a glass funnel with a bottom orifice of 17 mm according to the following method:
the glass funnel is filled with the powdered material (M) up to 5 mm from the top,
the cap blocking the bottom orifice is removed,
the flow time of the powder is measured with a stopwatch.

If flow does not take place, or if the flow stops, the funnel is tapped with a tool (e.g. a marker or a spatula) until the flow resumes. The total flow time and the number of taps using the tool are recorded. For a given powder, the experiment is repeated 3 times, and the average total flow time and the average number of taps are reported.

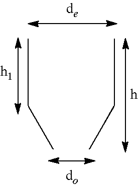

The dimensions of the funnel are: dₑ=40 mm, dₒ=17 mm, h=110 mm and h₁=70 mm.

PSD (d_{0.5}, d_{0.9})

The PSD (volume distribution) of the powdered materials were determined by an average of 3 runs using laser scattering Microtrac S3500 analyzer in wet mode (128 channels, between 0.0215 and 1408 μm). The solvent was isopropanol with a refractive index of 1.38 and the particles were assumed to have a refractive index of 1.59. The ultrasonic mode was enabled (25 W/60 seconds) and the flow was set at 55%.

TABLE 1

| | | | Average | Average | | | |
|---|---|---|---|---|---|---|---|
| | | MFR | Flow | # of | | | |
| | | (g/10 | Time | Taps to | d_{0.5} | d_{0.9} | d_{0.99} |
| Ex | PPS | min) | (s) | Flow | (μm) | (μm) | (μm) |
| 1 | #3 | 55 | 15.4 | 14 | 55.64 | 100.1 | 209.3 |
| 2 | #1 | 123 | 14.2 | 8 | 44.92 | 79.43 | 171.3 |
| 3 | #4 | 130 | 62.3 | 100 | 32.16 | 65.77 | 191.9 |
| 4c | #2 | 210 | 73.0 | 100 | 27.72 | 50.07 | 92.1 |
| 5 | #3 | 55 | 10.2 | 6 | 52.57 | 80.3 | 92.57 |
| 6 | #1 | 123 | 13.7 | 10 | 50.27 | 78.55 | 132.6 |
| 7 | #4 | 130 | 26.5 | 21 | 33.01 | 62.35 | 140.8 |
| 8c | #2 | 210 | 38.6 | 50 | 28.54 | 52.42 | 114.1 |

SLS Printing Process and Creation of Tensile Specimens

Specimens were prepared via SLS printing using an EOS® P800 laser sintering printer. The powder of example 6 (Tm=290° C.) was sintered into Type I ASTM tensile specimens using a laser power setting of 17 W, a processing temperature (Tp) of 285° C., a print duration of less than 1.5 hours, and a cooling rate of less than 10° C./min.

Tensile testing: the bars were tested according to ASTM D638, using ASTM Type I tensile bars

Key Printing Parameters:
1. Processing Temperature (Tp): 285° C.
2. Hatch Laser Power: 17 W
3. Contour Laser Power: 8.5 W
4. Laser Speed: 2.65 m/s

Results: Successful sintering occurred, with a resultant tensile strength of 53 MPa.

1-15. (canceled)

16. A powdered material (M) for laser sintering, comprising a polymeric component (P) comprising at least one poly(arylene sulfide) polymer (PAS), having a melt flow rate MFR (at 316° C. under a weight of 5 kg according to ASTM D1238, procedure B) of less than 160 g/10 min.

17. The material (M) of claim 16, having an average flow time such that its passage time in a 17 mm funnel is less than 35 s.

18. The material (M) of claim 17, having an average number of taps to flow of less than 30 taps.

19. The material (M) of claim 16, wherein the powdered material (M) has a d_{0.5}-value ranging from 40 and 80 μm, as measured by laser scattering in isopropanol.

20. The material (M) of claim 16, wherein the PAS polymer is selected from the group consisting of poly(2,4-toluene sulfide), poly(4,4′-biphenylene sulfide), poly(para-phenylene sulfide) (PPS), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecylphenylene sulfide), poly(phenylphenylene sulfide), poly-(tolylphenylene sulfide), poly(benzylphenylene sulfide), poly[octyl-4-(3-methylcyclopentyl)phenylene sulfide], or a combination thereof.

21. The material (M) of claim 16, wherein the PAS is a PPS comprising recurring units (R_{PPS}) represented by Formula I: 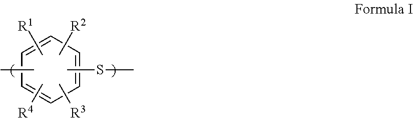
wherein R¹, R², R³, and R⁴ independently can be hydrogen or a substituent, selected from the group consisting of halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups.

22. The material (M) of claim 16, wherein the PAS is a PPS comprising at least 50 mol. % of recurring units (R_{PPS}) represented by Formula II: 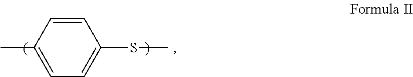
the mol. % being based on the total number of moles in the PAS.

23. The material (M) of claim 16, further comprising at least one additive (A) selected from the group consisting of fillers, colorants, dyes, pigments, lubricants, plasticizers, flame retardants, nucleating agents, heat stabilizers, light stabilizers, antioxidants, processing aids, fusing agents, electomagnetic absorbers and combinations thereof.

24. A method for manufacturing a three-dimensional (3D) object, comprising:
a) depositing successive layers of the powdered material (M) of claim 16,
b) selectively sintering each layer prior to deposition of the subsequent layer.

25. The method of claim 24, wherein step b) comprises selective sintering by means of an electromagnetic radiation of the powder.

26. A three-dimensional (3D) object obtainable by laser sintering from the powdered material (M) of claim 16.

27. Use of the powdered material (M) of claim 16, for the manufacture of a three-dimensional (3D) object using additive manufacturing, preferably selective laser sintering (SLS), composite-based additive manufacturing technology (“CBAM”) or jet mill fusion (JMF).

28. The use of claim 27 wherein the additive manufacturing is selected from the group consisting of selective laser sintering (SLS), composite-based additive manufacturing technology (“CBAM”) and jet mill fusion (JMF)

29. Use of a poly(arylene sulfide) polymer (PAS) for the manufacture of powdered material (M) having an average flow time such that its passage time in a 17 mm funnel is less than 35 s, preferably less than 30 s, even more preferably less than 28 s.

30. Use of the PAS of claim 29, wherein the PAS has a doss-value of less than 210 μm, as measured by laser scattering in isopropanol.

31. Use of the PAS of claim 29, wherein the PAS has a melt flow rate (at 316° C. under a weight of 5 kg according to ASTM D1238, procedure B) of less than 160 g/10 min.
